(19) United States
(12) Patent Application Publication
(10) Pub. No.: US 2026/0154531 A1
(43) Pub. Date: Jun. 4, 2026

(54) SYSTEMS AND METHODS FOR A DYNAMIC DATA MODEL

(71) Applicant: JPMORGAN CHASE BANK, N.A., New York, NY (US)

(72) Inventors: Saurabh GUPTA, Secaucus, NJ (US); Deepak JAYADAS, Newark, DE (US); Deepak JHA, Bournemouth (GB); Sarita BAKST, Brooklyn, NY (US); Valeriy OSIPOV, Baltimore, MD (US)

(21) Appl. No.: 18/964,142

(22) Filed: Nov. 29, 2024

(51) Int. Cl. G06N 3/0455; G06N 3/048; G06N 3/084

(52) U.S. Cl. CPC G06N 3/0455; G06N 3/048; G06N 3/084

(57) ABSTRACT

In some aspects, the techniques described herein relate to a method including: receiving an input text prompt at a machine learning model, the input text prompt including a type of application and a data; mapping, by a text encoder, the input text prompt to a representation space; generating, by a small language model, contextual embeddings for the type of application and the data specified in the input text prompt, wherein a character of each word of the input text prompt encoded with a numerical value; storing, by a computer program, the contextual embeddings in a model repository; assigning, by the computer program, one or more unique tags to the contextual embeddings; generating, by the computer program, a semantic score match based on a data model; generating a visualization of the data model; and generating a script to be executed on a target system for the data model.

### BACKGROUND

### 1. Field of the Invention

Embodiments generally relate to systems and methods for data modeling.

### 2. Description of the Related Art

Current data management systems are cumbersome and require cycles of iterative restructuring. Current data management systems require expert personnel to create conceptual models, refine the conceptual models into logical models, and then implement the logical models as physical models. This process is time-consuming, inefficient, and expensive. Further, consistency across current data models or even within the same data model can be difficult to maintain due to different implementation and/or development techniques from person to person or across time. Resolving errors can also be difficult in current data models. As data models may vary, the requirements for expert personnel to maintain and enforce compliance for the data models may increase. The implementation of compliance and standards is thus problematic in current systems.

### SUMMARY

According to some embodiments, the techniques described herein relate to a method including steps stored on a memory of computer to be executed by a processor of the computer, the steps including: A method including steps including: receiving, by a computer program executed by one or more processors, an input text prompt at a machine learning model, the input text prompt including a type of application and a data of a target system, the target system comprising a memory on which the data is stored; generating, by the computer program, a small language model comprising an encoder and a decoder, the encoder and the decoder each comprising a self-attention layer, wherein the small language model is trained on data relevant to the type of application and generates one or more weights based on the training; generating, by the small language model, contextual embeddings for the type of application and the data specified in the input text prompt, wherein each word of the input text prompt is encoded with a numerical value and multiplied by the one or more weights; mapping, by the small language model, the input text prompt to a representation space; storing, by the small language model, the contextual embeddings in a model repository; assigning, by the small language model, one or more unique tags to the contextual embeddings; matching, by the computer program, the representation space to a corresponding data model based on a semantic score match; generating, by the computer program, a visualization of the data model based on the data of the target system; and generating, by the computer program, a script to be executed on the target system to implement the data model on the data of the target system.

In some embodiments, the decoder may further comprise an attention score layer, the attention score layer configured to calculate a cosine plus normalized text score. In some embodiments, the self-attention layer may be configured to calculate an amplified key parameter and an amplified query parameter, and wherein the self-attention layer calculates a self-attention score based on the amplified key parameter and the amplified query parameter. In some embodiments, the self-attention layer may be configured to enhance the self-attention score using an activation function. In some embodiments, the activation function may be a Leaky RELU activation function. In some embodiments, the encoder may comprise a number of encoders and the decoder comprises a corresponding number of decoders, wherein the training data is passed through the number of encoders and the number of decoders to update one or more weight based on the training data. In some embodiments, the method may further comprise a step of: hierarchical clustering, by the computer program, of one or more domain topics based on the type of application.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 illustrates a flowchart for a machine learning engine to generate a data model.

FIG. 2 illustrates a data model.

FIG. 3A illustrates a small language model.

FIG. 3B illustrates an exemplary activation function.

FIG. 4 illustrates a block diagram of a computing device for data modeling.

### DETAILED DESCRIPTION

Embodiments generally relate to systems and methods for data modeling.

Conventionally, expert personnel would design a conceptual model, a logical model, and a physical model of a data model through an iterative and time-consuming process based on personal domain expertise or working with subject matter experts. The conceptual model includes semantics of a domain. The conceptual model establishes entities of the domain and relationships between entities of the domain. The logical model includes data attributes and keys within the entities of the conceptual model. The physical model includes establishing table and column names and data types for each entity according to database technology it is to be implemented on. The conceptual, logical, and physical models may not comply, may include errors, may be inefficient, and may be inconsistent if set up by inexperienced personnel. The data model may be a real-world system used to collect, store, and maintain data. Data models may be used to efficiently store consumer information such as credit card information, e-commerce information, medical information, or other types of large databases.

Disclosed embodiments include an application or software program including a list of instructions that, when executed by a processor of a computer, cause the processor to create data models. The application or software program may include a language model trained on curated data that processes an input text prompt. The language model may be a small language model. The small language model may be a type of artificial intelligence model that understands and generates human language to solve domain specific use cases. The application or software program may be configured to generate the data model based on a problem description in natural language and may align the model to business domain knowledge. The application or software program may be configured to generate a model to support business process, record business events, and track performance measures. The application or software program may be configured to generate a data model that contains entities that are required for an input application system. Embodiments may provide benefits of providing a timely, accurate, efficient, and complete data model. Further, the data model may be replicated efficiently and consistently. For example, terminology may be consistent across one or more data models.

Further, personal information and other sensitive data such as proprietary data may be protected within the generated data model. As another benefit, data models may be updated efficiently and quickly. Further, the application or software program may be tuned or enhanced based on previous prompts and/or feedback. The application or software program may be cost-effective because it reduces cycles of review and rework, allows efficient reviews, is able to retrain based on feedback, uses cloud-enabled services, and it may be exposed as a service because it is application programming interface (API) driven. In some embodiments, outputs of the application or software program may be a data definition language (DDL) script that may be available for many database types. Similarly, outputs may be a data model with specification in a standardized format (e.g., JSON or an objects framework) to produce scripts for inter-operability and portability into different databases and/or database management systems.

The application or software program may include hierarchical decoding that allows the program to decode each key value pair at each level. The hierarchical decoding allows deriving the parent-child relationships that inherently exist in a data model. Further, the hierarchical decoding allows tracing of the lineage of a data attribute even if the data attributed plays different roles in different entities/databases/models.

Outputs of the application or software program may include adapters for reverse engineering and/or fine tuning. The adapters may be software that takes a logical data model and produces artifacts to be implemented on a target data platform. In other words, the physical data model may be engineered based on the logical data model/database management system. The software program may be configured to allow visualization of each data model output of the application or software program.

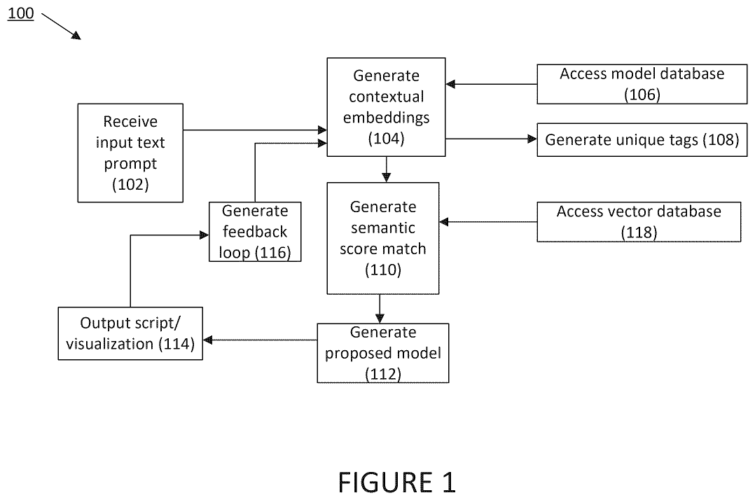

FIG. 1 is a flowchart for generating a data model.

Method 100 may be a method of generating a data model consistent with disclosed embodiments.

Method 100 may include a step 102 of receiving an input text prompt at a computer program for generating a model comprising a machine learning model. The input text prompt may be free form. The input text prompt may include a type of application and a data the user wishes to capture. The type of application may be a business requirement. The computer program may input the input text prompt to the machine learning model. Step 102 may include a text encoder that is trained to map the prompt to a representation space. The representation space may be used to simplify the data representation and features for the purpose of finding patterns. In other words, the representation space compresses the encoded information to fewer bits than the original data from the input. This means extraneous data will be removed for efficiency so that inferences may be more accurate and may be made more quickly.

At step 104, contextual embeddings may be generated by a small language model. In some embodiments, the contextual embeddings may be generated by a small language model as an instance of or in operative communication with the machine learning model. The small language model (“SLM”) may be custom trained on data models so as to efficiently generate contextual embeddings for the type of application and the data specified in the input text prompt. Contextual embeddings may be processed by a customized tokenization technique. Contextual embeddings may be created by an initial pre-processing technique used for training the SLM. The unique characters of each word in the training corpus may be encoded with a numerical value. This is then fed to the SLM. Redefined attention layers give weightage to the modeling data for training and inferencing. The custom self attention layers may help provide better convergence of the data model and faster and training and inferences for a LLM generating data models.

The custom self-attention layer may be generated according to the following equation:

$$( Z ) = L U ( \frac{( Q \cdot {K}^{t} )}{\sqrt{{d}^{k}}} V ) , where LU is = \{ x if x > 0 , otherwise 0.01 x )$$

The custom self-attention layer is a block inside the encoder and decoder blocks of the basic transformer architecture, and it may provide a context of the input text based on the correlation matrix. For the training of the custom LLM, a Leaky Rectified Linear Unit (“RelU”) function may be used to significantly reduce a vanishing gradient. In machine learning, an optimization process plays a crucial role in training language models. Gradient descent, a fundamental optimization algorithm, can sometimes encounter vanishing gradient challenges. Particularly with multiple layers, the vanishing gradient can prevent or hamper effective training of the language model. This occurs in part because the weight updates may become negligible. The Leaky RelU function may be an activation function that prevents the function from becoming saturated at 0.

The amplified key parameter may be amplified according to the following equation:

$$( K ) = α \frac{( {e}^{l - 1} - {e}^{- ( l - 1 )} )}{( {e}^{l - 1} + {e}^{- ( l - 1 )} )} + β 1$$

The amplified key parameter may be a component required to calculate the custom self-attention layer at each encoder and decoder level. The “l” may be the current embedding layer, and “l-1” may be the previous embedding layer.

The “α” may be a weighting average from a previous embedding layer (if one exists) and may vary from zero to one of the current layer “l” and apply a sigmoid function on the previous layer.

The “β” may be a weighting average from a current embedding layer. The “β” may vary from zero to one of the current layer “l”.

The custom self-attention scores calculate the correlation of the training text and helps in better context definition while training the custom LLM. The amplified key parameter may be initialized at the start of training process and subsequently updated at each iteration. The key parameter may be a linear layer initialized with random weights and that is updated at each iteration. This key parameter is modified with a different kind of linear layer called the amplified key parameter.

The custom self-attention score also requires an amplified query parameter as defined according to the following equation:

$$( Q ) = ( l - 1 ) ( f ( l - 1 ) ) + β1 , where f ( x ) = x if x > 0 , or a ( {e}^{x} - 1 )$$

In the above equation, “a” is greater than 0 and, in some cases, may be 0.001. In the above equation, l-1 may be the last embedding layer. The amplified query parameter may be a basic block of a custom LLM. In some cases, an exponential linear unit may be applied to make an activation function closer to zero for better accuracy. The activation function may be a function that activates a particular network layer based on a particular input value by returning a higher value. Activation functions may include sigmoid, ReLU and Leaky RelU and exponential linear units (“ELUs”). After experimentation, the optimal activation function for the custom LLM is ELU.

At step 106, by the computer program, the contextual embeddings may be stored in a model repository and/or the model repository may be accessed. The model repository may be a self-contained data model that ensures safety of sensitive information. In some embodiments, encryption may be used to protect the self-contained data model. The access model database may include previously generated models. In some embodiments, the access model database may include exemplary data models and/or scripts for implementation. The exemplary data models and/or scripts for implementation may be used to train the machine learning model.

At step 108, by the computer program, the contextual embeddings may be assigned generated unique tags. The unique tags may provide faster searching for a LLM because logical models that belong to a particular category may be quickly and efficiently searched.

At step 110, a semantic score match may be generated for each embedding. The semantic score is calculated using the cosine angle of the vector embeddings of the input prompt and the trained data.

$$cos θ = \frac{\vec{a} \cdot \vec{b}}{‖ a ‖ \cdot ‖ b ‖} ,$$

where \vec{a}, \vec{b} are vectors embeddings. The semantic score is the cosine similarity of the input (\vec{a}) and training data (\vec{b})

The semantic score match may be calculated based on a cosine plus a normalized text score. The semantic score match may be based on relevance of a model to the input prompt text. The semantic score match may be generated by computing a sum of the cosine similarities between token embeddings, thereby providing the capability to detect paraphrases alone or together with n-gram matching of words or key phrases.

At step 112, one or more suggested data models may be proposed. The data models may be generated by the computer program as structured query language (SQL) for implementation of the suggested data model.

At step 114, results may be output and displayed. In some embodiments, the user may select a model from the suggested model. The output may be visualized using an adapter. The output may be visualized including metadata of the data model. The data model output visualization may include a customer identifier and customer details and a related account identifier and account details. In some embodiments, the output may be a data definition language (DDL). The DDL may be configured to restructure a relational database. The relational database may be located on a target system comprising a memory. The relational database may be stored on a memory accessible over a network or the internet. The output may be a script that can be executed to affect the data model generation or regenerate (e.g., restructure) an existing data model. The output may be a more efficient hierarchal clustering of the data for faster searching. Further, the output may include a data model where the data may be stored efficiently based on the semantic similarity match.

At step 116, by the computer program, a feedback loop may be implemented based on a selected model. The feedback loop may be based on the model repository. In some embodiments, the feedback loop may be based on the selected model. In some embodiments, the feedback loop may be based on a directed retraining of the language model by a retraining model based on a determined quality of the suggested models. The determined quality may be based on a magnitude of a confidence score.

At step 118, by the computer program, a vector database may be accessed to store and/or access stored embeddings. The stored embeddings may be used in step 110 to generate embeddings tables for the dataset which are properly labeled with a domain and/or topic/context information.

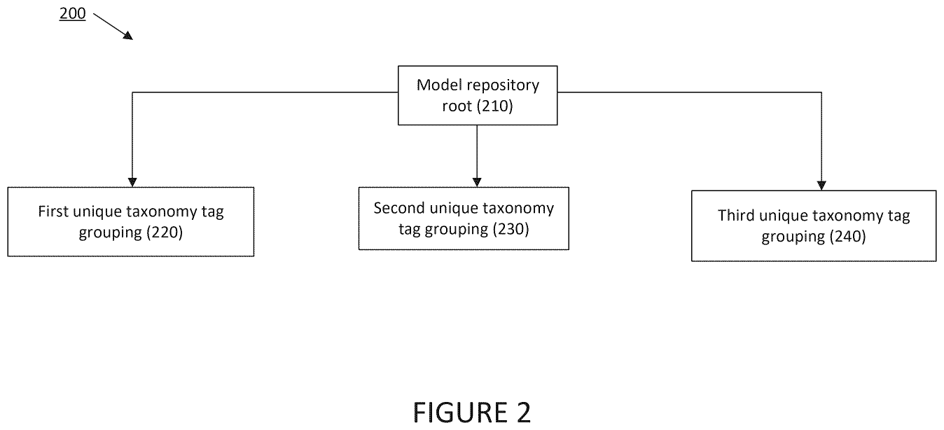

FIG. 2 is a flowchart for user generating a data model.

Data model 200 may include model repository root 210. Data model 200 may be implemented to perform clustering for faster searches. The searches can be based on similarity matching and/or user feedback. The similarity scores are calculated based on the input prompt description by the user and how they match to the relevant clustered logical data model “LDM”/physical data model “PDM”/conceptual data model “CDM” defined. The CDM may describe a semantic of a domain by establishing entities and relationships between the entities. The LDM may include data attributes and defining keys to relationships between entities. The PDM may include table and column names and/or data types of the entities. Training optimization is accomplished by creating custom categories which help in matching the context of the input values. The creation of custom categories helps faster training of a SLM and/or LLM and to accomplish inference steps. By providing the context of the logical categories the machine learning engine(s) may match the input match term to the relevant input LDM/PDM/CDMs.

Data model 200 may include first unique taxonomy tag grouping 220, second unique taxonomy tag grouping 230, and third unique taxonomy tag grouping 240. The unique taxonomy tag groupings may be assigned for a first data type. First unique taxonomy tag grouping may be based on embeddings related to custom topics. Sub-groups of first unique taxonomy tag grouping may be clusters based on sub-topics or individual topics within first unique taxonomy tag grouping. Second unique taxonomy tag grouping may be based on custom topics. Sub-groups of second unique taxonomy tag grouping may be clusters based on sub-topics or individual topics within the second unique taxonomy tag grouping. Third unique taxonomy tag grouping may be based on a context and the custom topics, stored together. The context may be words or phrases determined by the LLM to be a context. The context may be a source document referenced or uploaded to the LLM.

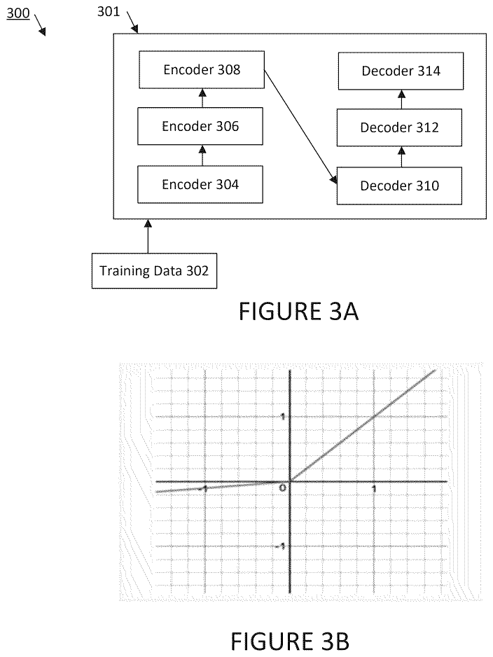

FIG. 3A illustrates a small language model.

System 300 may include a small language model (“SLM”) 301. SLM 301 may receive training data 302, for example from an exemplary computer program. SLM 301 may include a number of encoders such as encoders 304, 306, 308. SLM 301 may include a number of decoders such as decoders 310, 312, 314. Training data 302 may be a result of existing conventional LDMs, CDMs, and PDMs that are verified as correct. The SLM 301 may involve hierarchical encoding and decoding, which helps with context awareness.

For each training data 302, the data may be passed through a series of encoders such as encoders 304, 306, 308, and then through a series of decoders 310, 312, 314. The number of decoders may equal the number of encoders. Any number of encoders and a corresponding number of decoders is contemplated. Each encoder may include a feed forward layer and a custom self-attention layer, consistent with disclosed embodiments. Each decoder may include a feed forward layer, an encoder-decoder attention score layer, and a custom self-attention layer, consistent with disclosed embodiments. Each decoder may decode each key value pair at each level. The SLM 301's inclusion of the encoder and decoder layers results in more efficient (i.e., less computing power, faster resolution) understanding of input text.

An output of SLM 301 may be trainable labelled texts that can be used for more accurate and efficient conversion and labelling. The conversion may be of data to JSON format training schemas.

FIG. 3B illustrates an exemplary activation function.

The activation shown in FIG. 3B is a Leaky RELU activation function. The Leaky RELU activation function may significantly reduce a vanishing gradient issue for self-attention score. This may be performed during a self-attention layer as discussed above. The Leaky RELU activation function may help with faster convergence and training of a SLM.

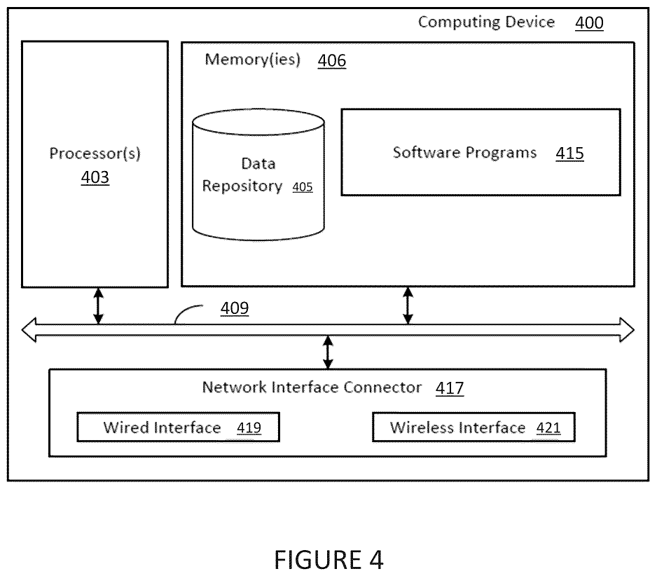

FIG. 4 is a block diagram of a computing device for implementing certain aspects of the present disclosure. FIG. 4 shows exemplary computing device 400. Computing device 400 may represent hardware that executes the logic that drives the various system components described herein. For example, system components such as a ML model engine, an interface, various database engines and database servers, and other computer applications and logic may include, and/or execute on, components and configurations like, or similar to, computing device 400.

Computing device 400 includes a processor 403 coupled to a memory 406. Memory 406 may include volatile memory and/or persistent memory. The processor 403 executes computer-executable program code stored in memory 406, such as software programs 415. Software programs 415 may include one or more of the logical steps disclosed herein as a programmatic instruction, which can be executed by processor 403. Memory 406 may also include data repository 405, which may be nonvolatile memory for data persistence. The processor 403 and the memory 406 may be coupled by a bus 409. In some examples, the bus 409 may also be coupled to one or more network interface connectors 417, such as wired network interface 419, and/or wireless network interface 421. Computing device 400 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, Python, R, APL, C, C++, Scala, Java, Modula-2, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method including steps including:
receiving, by a computer program executed by one or more processors, an input text prompt at a machine learning model, the input text prompt including a type of application and a data of a target system, the target system comprising a memory on which the data is stored;
generating, by the computer program, a small language model comprising an encoder and a decoder, the encoder and the decoder each comprising a self-attention layer, wherein the small language model is trained on data relevant to the type of application and generates one or more weights based on the training;
generating, by the small language model, contextual embeddings for the type of application and the data specified in the input text prompt, wherein each word of the input text prompt is encoded with a numerical value and multiplied by the one or more weights;
mapping, by the small language model, the input text prompt to a representation space;
storing, by the small language model, the contextual embeddings in a model repository;
assigning, by the small language model, one or more unique tags to the contextual embeddings;
matching, by the computer program, the representation space to a corresponding data model based on a semantic score match;
generating, by the computer program, a visualization of the data model based on the data of the target system; and
generating, by the computer program, a script to be executed on the target system to implement the data model on the data of the target system.

2. The method of claim 1, wherein the decoder further comprises an attention score layer, the attention score layer configured to calculate a cosine plus normalized text score.

3. The method of claim 1, wherein the self-attention layer is configured to calculate an amplified key parameter and an amplified query parameter, and wherein the self-attention layer calculates a self-attention score based on the amplified key parameter and the amplified query parameter.

4. The method of claim 3, wherein the self-attention layer is configured to enhance the self-attention score using an activation function.

5. The method of claim 4, wherein the activation function is a Leaky RELU activation function.

6. The method of claim 1, wherein encoder comprises a number of encoders and the decoder comprises a corresponding number of decoders, wherein the training data is passed through the number of encoders and the number of decoders to update one or more weight based on the training data.

7. The method of claim 1, further comprising a step of:
hierarchical clustering, by the computer program, of one or more domain topics based on the type of application.

8. A computer processing system comprising:
a memory configured to store instructions; and
a hardware processor operatively coupled to the memory for executing the instructions of a text or call processing program to:
receive, by a computer program executed by one or more processors, an input text prompt at a machine learning model, the input text prompt including a type of application and a data of a target system, the target system comprising a memory on which the data is stored;
generate, by the computer program, a small language model comprising an encoder and a decoder, the encoder and the decoder each comprising a self-attention layer, wherein the small language model is trained on data relevant to the type of application and generates one or more weights based on the training;
generate, by the small language model, contextual embeddings for the type of application and the data specified in the input text prompt, wherein each word of the input text prompt is encoded with a numerical value and multiplied by the one or more weights;
map, by the small language model, the input text prompt to a representation space;
store, by the small language model, the contextual embeddings in a model repository;
assign, by the small language model, one or more unique tags to the contextual embeddings;
match, by the computer program, the representation space to a corresponding data model based on a semantic score match;
generate, by the computer program, a visualization of the data model based on the data of the target system; and
generate, by the computer program, a script to be executed on the target system to implement the data model on the data of the target system.

9. The system of claim 8, wherein the decoder further comprises an attention score layer, the attention score layer configured to calculate a cosine plus normalized text score.

10. The system of claim 8, wherein the self-attention layer is configured to calculate an amplified key parameter and an amplified query parameter, and wherein the self-attention layer calculates a self-attention score based on the amplified key parameter and the amplified query parameter.

11. The system of claim 10, wherein the self-attention layer is configured to enhance the self-attention score using an activation function.

12. The system of claim 11, wherein the activation function is a Leaky RELU activation function.

13. The system of claim 8, wherein encoder comprises a number of encoders and the decoder comprises a corresponding number of decoders, wherein the training data is passed through the number of encoders and the number of decoders to update one or more weight based on the training data.

14. The method of claim 8, further comprising a step of:
hierarchical clustering, by the computer program, of one or more domain topics based on the type of application.

15. A non-transitory computer readable storage medium, including instructions stored thereon, which when read and executed by one or more computer processors, cause the one or more computer processors to perform steps comprising:
receiving, by a computer program executed by one or more processors, an input text prompt at a machine learning model, the input text prompt including a type of application and a data of a target system, the target system comprising a memory on which the data is stored;
generating, by the computer program, a small language model comprising an encoder and a decoder, the encoder and the decoder each comprising a self-attention layer, wherein the small language model is trained on data relevant to the type of application and generates one or more weights based on the training;
generating, by the small language model, contextual embeddings for the type of application and the data specified in the input text prompt, wherein each word of the input text prompt is encoded with a numerical value and multiplied by the one or more weights;
mapping, by the small language model, the input text prompt to a representation space;
storing, by the small language model, the contextual embeddings in a model repository;
assigning, by the small language model, one or more unique tags to the contextual embeddings;
matching, by the computer program, the representation space to a corresponding data model based on a semantic score match;
generating, by the computer program, a visualization of the data model based on the data of the target system; and
generating, by the computer program, a script to be executed on the target system to implement the data model on the data of the target system.

16. The non-transitory computer readable storage medium of claim 15, wherein the decoder further comprises an attention score layer, the attention score layer configured to calculate a cosine plus normalized text score.

17. The non-transitory computer readable storage medium of claim 15, wherein the self-attention layer is configured to calculate an amplified key parameter and an amplified query parameter, and wherein the self-attention layer calculates a self-attention score based on the amplified key parameter and the amplified query parameter.

18. The non-transitory computer readable storage medium of claim 17, wherein the self-attention layer is configured to enhance the self-attention score using an activation function.

19. The non-transitory computer readable storage medium of claim 18, wherein the activation function is a Leaky RELU activation function.

20. The non-transitory computer readable storage medium of claim 1, wherein encoder comprises a number of encoders and the decoder comprises a corresponding number of decoders, wherein the training data is passed through the number of encoders and the number of decoders to update one or more weight based on the training data.
